(19) United States
(12) Patent Application Publication
(10) Pub. No.: US 2025/0293271 A1
(43) Pub. Date: Sep. 18, 2025

(54) BIPOLAR PLATE STRUCTURE, METHOD OF MANUFACTURING SAME, AND FLOW BATTERY

(71) Applicant: VRB Energy Inc., Grand Cayman (KY)

(72) Inventors: Changhui Song, Beijing (CN); Xingsheng Zhou, Beijing (CN); Hao Yang, Beijing (CN); Zhiling Zhao, Beijing (CN); Hedi Ma, Beijing (CN); Huichao Liu, Beijing (CN); Qiming Ge, Beijing (CN)

(21) Appl. No.: 18/750,309

(22) Filed: Jun. 21, 2024

(30) Foreign Application Priority Data
Mar. 15, 2024 (CN) 202410299234.4

(51) Int. Cl. H01M 8/0221; H01M 8/0226; H01M 8/18

(52) U.S. Cl. CPC H01M 8/0221; H01M 8/0226; H01M 8/188

(57) ABSTRACT

The present application provides a bipolar plate structure, a method of manufacturing the same, and a flow battery. The bipolar plate structure includes a bipolar plate body, both side surfaces of which each include a covered region covered by an electrode and a circumferential edge region not covered by the electrode, wherein the circumferential edge region is covered by a housing made of a modified polypropylene, and the modified polypropylene is prepared by blending and modifying polypropylene-graft-maleic anhydride, poly(ethylene-octene)-graft-maleic anhydride and polypropylene. The bipolar plate structure of the present application avoids leakage problems, and enhances the overall performance of the flow battery and system stability due to the edge region of the bipolar plate body being covered by the housing with enhanced mechanical performance, aging resistance, oxidation resistance, etc.

### RELATED APPLICATIONS

This application claims priority to Chinese Patent Application No. 202410299234.4, filed Mar. 15, 2024, and titled BIPOLAR PLATE STRUCTURE, METHOD OF MANUFACTURING SAME, AND FLOW BATTERY, which is incorporated herein by reference in its entirety.

### TECHNICAL FIELD

The present application relates to, but is not limited to, the field of electrochemistry, and in particular to a bipolar plate structure, a method of manufacturing the same, and a flow battery.

### BACKGROUND

A bipolar plate is one of key components of a flow battery, functions to connect positive and negative electrodes of different cells and conduct the circuit within the battery, and is required to have good conductivity, high mechanical strength, and resistance to chemical oxidation and electrochemical corrosion of the flow battery. Due to the requirements of the working environment of the bipolar plate, if the bipolar plate is made of a common material, a region thereof that is not covered by an electrode, i.e., the circumferential edge region of the electrode plate, will be corroded when it comes into contact with an electrolyte, thereby easily causing internal leakage of the battery, and affecting the normal use of the battery. At present, to overcome this problem, bipolar plates are mainly made of materials with high corrosion resistance. However, the bipolar plates made of materials with high corrosion resistance will have higher costs.

Therefore, there is a need for a cost-effective and performance-improved bipolar plate structure, a method of manufacturing the same, and a flow battery including the same.

### SUMMARY

The following is a summary of the subject matter described in detail herein. This summary is not intended to limit the scope of protection of the claims.

In one aspect, an exemplary embodiment of the present disclosure provides a bipolar plate structure comprising a bipolar plate body, both side surfaces of which each comprise a covered region covered by an electrode and a circumferential edge region not covered by the electrode;
wherein the circumferential edge region is covered by a housing made of a modified polypropylene, and the modified polypropylene is prepared by blending and modifying polypropylene-graft-maleic anhydride, poly(ethylene-octene)-graft-maleic anhydride and polypropylene.

As used in the present application, the term “circumferential edge region” refers to a region surrounding the circumferential direction of the bipolar plate body and outside the bipolar plate body, which is a region not covered by an electrode and an electrolyte and in which relevant electrochemical reactions do not occur.

The bipolar plate body may have a square shape, a rectangular shape, a circular shape or the like, and the housing may thus correspondingly have a square shape, a rectangular shape, a circular shape or the like that is hollow.

In some embodiments, raw materials for preparing the modified polypropylene comprise, in parts by weight, 55 to 95 parts of polypropylene, 5 to 15 parts of polypropylene-graft-maleic anhydride, 10 to 20 parts of poly(ethylene-octene)-graft-maleic anhydride, 1 to 2 parts of nano SiO₂, 1 to 2 parts of talc, 0.5 to 1 part of a coupling agent, 0.1 to 1.5 parts of carbon black, and 0.3 to 1.4 parts of an antioxidant.

In some embodiments, the antioxidant is one or both selected from antioxidant 168 and antioxidant 1010.

In some embodiments, the antioxidant consists of antioxidant 168 and antioxidant 1010 in a weight ratio of 1:1 to 3:2. For example, the antioxidant consists of antioxidant 168 and antioxidant 1010 in a weight ratio of 3:2.

In some embodiments, the coupling agent is one or more selected from coupling agents KH-550, KH-560 and KH570, 3-aminopropyltrimethoxysilane and vinyltriethoxysilane.

In the present disclosure, antioxidant 1010 acts as a radical trapping agent and antioxidant 168 acts as an auxiliary agent. The combination of the two can maximize the antioxidant effect, and by adding the coupling agent, the adhesion of the housing to the bipolar plate body can be enhanced.

In some embodiments, the housing and the bipolar plate body form an integrated structure.

In another aspect, an exemplary embodiment of the present application provides a method of manufacturing the bipolar plate structure described above, comprising the following steps:
weighing and mixing components to form a raw material mixture;
melt-kneading, extruding, cooling and drying, and pelletizing the raw material mixture to obtain modified polypropylene particles;
mounting a bipolar plate body into an injection mold; and
injecting molten modified polypropylene particles into the injection mold and injection-molding, cooling and demolding to obtain a bipolar plate structure with a housing.

In some embodiments, the injection mold has a cavity surrounding a circumferential edge of the bipolar plate body, and the molten modified polypropylene particles are injected into the cavity to form a housing that forms an integrated structure with the bipolar plate body.

In some embodiments, the extruding is carried out by a twin-screw extruder; the twin-screw extruder comprises a first zone, a second zone, a third zone, a fourth zone, and a fifth zone in sequence; the temperature of the first zone is set in the range of 150° C. to 180° C., the temperature of the second zone is set in the range of 200° C. to 220° C., the temperature of the third zone is set in the range of 220° C. to 240° C., the temperature of the fourth zone is set in the range of 220° C. to 240° C., and the temperature of the fifth zone is set in the range of 220° C. to 240° C.; and the rotational speed of a main engine is 300 rpm.

In yet another aspect, an exemplary embodiment of the present application provides a flow battery comprising the bipolar plate structure described above.

In another aspect, it is provided in the exemplary embodiment of the present application that the flow battery is any one selected from an all-vanadium flow battery, an iron-chromium flow battery, a zinc-iron flow battery, and a zinc-bromine flow battery.

The bipolar plate structure with the housing of the present application has enhanced oxidation resistance, aging resistance and other properties, and is more resistant to corrosion by an electrolyte or the like, thereby improving the reliability and stability of the entire flow battery.

The bipolar plate structure of the present application has the housing and the bipolar plate body in an integrated structure, so that the housing covering the bipolar plate body is more stable, the sealing effect is better, and it is easier to prevent the displacement of the insulating region of the bipolar plate during installation and charging or discharging of a flow battery stack.

The manufacturing process of the bipolar plate structure with the housing of the present application is simple, which significantly reduces the manufacturing cost of the flow battery and improves the economic efficiency.

Other features and advantages of the present application will be set forth in the following description, and in part will become apparent from the description, or will be understood by means of the implementation of the present application. Other advantages of the present application may be achieved and obtained by means of the solutions described in the description.

### BRIEF DESCRIPTION OF THE DRAWINGS

The accompanying drawings are used to provide an understanding of the technical solutions of the present application and constitute a part of the specification, and together with the embodiments of the present application, are used to explain the technical solution of the present application and not to limit the technical solution of the present application.

FIGS. 1A and 1B are schematic views of a bipolar plate structure including a housing provided by an exemplary embodiment of the present disclosure; and

FIGS. 2A and 2B are schematic views of an injection mold used in a method of manufacturing a bipolar plate structure provided by an exemplary embodiment of the present disclosure.

### DETAILED DESCRIPTION

To make the objects, technical solutions and advantages of the present application clearer, the embodiments of the present application will be described in detail below. It should be noted that, in the case of no conflict, the embodiments in the present application and the features in the embodiments may be arbitrarily combined with each other.

An exemplary embodiment of the present application provides a bipolar plate structure. The bipolar plate structure includes a bipolar plate body, both side surfaces of which each include a covered region covered by an electrode and a circumferential edge region not covered by the electrode, wherein the circumferential edge region is covered by a housing made of a modified polypropylene, and the modified polypropylene is prepared by blending and modifying polypropylene-graft-maleic anhydride, poly(ethylene-octene)-graft-maleic anhydride and polypropylene.

The modified polypropylene for preparing the housing in the present application may include the following raw materials: the raw materials including, in parts by weight, 55 to 95 parts of polypropylene, 5 to 15 parts of polypropylene-graft-maleic anhydride, 10 to 20 parts of poly(ethylene-octene)-graft-maleic anhydride, 1 to 2 parts of nano SiO2, 1 to 2 parts of talc, 0.5 to 1 part of a coupling agent, 0.1 to 1.5 parts of carbon black, and 0.3 to 1.4 parts of an antioxidant.

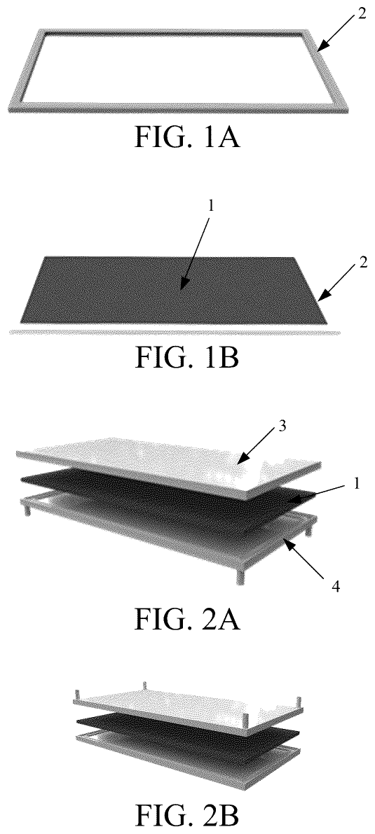

As shown in FIGS. 1A and 1B, the bipolar plate structure provided by the exemplary embodiment of the present application may include a bipolar plate body 1 and a housing 2 covering a circumferential edge of the bipolar plate body. FIGS. 2A and 2B show that an injection mold for manufacturing the bipolar plate structure of the present application may include a top mold 3 and a bottom mold 4.

The bipolar plate body used in the present application may be commercially available. The bipolar plate body may have front and back side surfaces, each of which may be covered with an electrode, such as carbon felt, carbon cloth, etc. Both side surfaces of the bipolar plate may also be sandwiched by a frame plate provided with serpentine flow channels, such as a plurality of serpentine flow channels arranged in parallel, in which an electrolyte may be provided.

An exemplary embodiment of the present application further provides a flow battery. The flow battery includes the bipolar plate structure described above, an ion exchange membrane and the like, which are assembled together to form the flow battery.

The following examples describe a method of manufacturing a bipolar plate structure of the present application.

The materials used in the following examples and comparative example are all commercially available materials (for example, polypropylene-graft-maleic anhydride and poly(ethylene-octene)-graft-maleic anhydride may each be selected from commercially available products having conventional graft ratios) unless otherwise specified.

### EXAMPLE 1

A method of preparing a bipolar plate structure of this example includes the following steps:
step 1: weighing the following components: 75 parts by weight of polypropylene (PP), 10 parts by weight of polypropylene-graft-maleic anhydride (PP-g-MAH), 15 parts by weight of poly(ethylene-octene)-graft-maleic anhydride (POE-g-MAH), 1.5 parts by weight of nano SiO₂, 1.5 parts by weight of talc, 1 part by weight of a coupling agent KH-550, 0.5 parts by weight of carbon black, 0.4 parts by weight of antioxidant 168 and 0.4 parts by weight of antioxidant 1010;
step 2: mixing the above components, stirring thoroughly and uniformly and then adding same into a twin-screw extruder, and melt-kneading, extruding, cooling and drying, and pelletizing to obtain modified polypropylene particles, wherein the temperature of a first zone of the twin-screw extruder is set at 170° C., the temperature of the second zone is set at 210° C., the temperature of the third zone is set at 230° C., the temperature of the fourth zone is set at 230° C., and the temperature of the fifth zone is set at 230° C.; and the rotational speed of a main engine is 300 rpm; and
step 3: mounting a top mold 3 and a bottom mold 4 of an injection mold on an injection molding machine, placing a bipolar plate body 1 between the top mold 3 and the bottom mold 4, injecting molten modified polypropylene into a cavity of the top mold 3 and the bottom mold 4, the cavity for forming a housing surrounding a circumferential edge region of the bipolar plate body, cooling and then demolding to obtain a bipolar plate structure with a housing, that is, a bipolar plate structure including the bipolar plate body 1 and the housing 2 in the form of an integrated structure.

### EXAMPLE 2

A method of preparing a bipolar plate structure of this example includes the following steps:
step 1: weighing the following components: 80 parts by weight of polypropylene (PP), 5 parts by weight of polypropylene-graft-maleic anhydride (PP-g-MAH), 12 parts by weight of poly(ethylene-octene)-graft-maleic anhydride (POE-g-MAH), 1 part by weight of nano SiO₂, 1 part by weight of talc, 0.6 parts by weight of a coupling agent KH-550, 0.4 parts by weight of carbon black, 0.3 parts by weight of antioxidant 168 and 0.2 parts by weight of antioxidant 1010;
step 2: mixing the above components, stirring thoroughly and uniformly and then adding same into a twin-screw extruder, and melt-kneading, extruding, cooling and drying, and pelletizing to obtain modified polypropylene particles, wherein the temperature of a first zone of the twin-screw extruder is set at 175° C., the temperature of the second zone is set at 215° C., the temperature of the third zone is set at 225° C., the temperature of the fourth zone is set at 230° C., and the temperature of the fifth zone is set at 230° C.; and the rotational speed of a main engine is 260 rpm; and □
step 3: mounting a top mold 3 and a bottom mold 4 of an injection mold on an injection molding machine, placing a bipolar plate body 1 between the top mold 3 and the bottom mold 4, injecting molten modified polypropylene into a cavity of the top mold 3 and the bottom mold 4, the cavity for forming a housing surrounding a circumferential edge region of the bipolar plate body, cooling and then demolding to obtain a bipolar plate structure with a housing, that is, a bipolar plate structure including the bipolar plate body 1 and the housing 2 in the form of an integrated structure.

### COMPARATIVE EXAMPLE 1 (USING A DIFFERENT RATIO FROM THE PRESENT APPLICATION)

A method of preparing a bipolar plate structure of this comparative example includes the following steps:
step 1: weighing the following components: 50 parts by weight of polypropylene (PP), 20 parts by weight of polypropylene-graft-maleic anhydride (PP-g-MAH), 5 parts by weight of poly(ethylene-octene)-graft-maleic anhydride (POE-g-MAH), 0.5 parts by weight of nano SiO₂, 0.5 parts by weight of talc, 0.4 parts by weight of a coupling agent KH-550, 0.05 parts by weight of carbon black, 0.3 parts by weight of antioxidant 168 and 0.3 parts by weight of antioxidant 1010;
step 2: mixing the above components, stirring thoroughly and uniformly and then adding same into a twin-screw extruder, and melt-kneading, extruding, cooling and drying, and pelletizing to obtain modified polypropylene particles, wherein the temperature of a first zone of the twin-screw extruder is set at 170° C., the temperature of the second zone is set at 210° C., the temperature of the third zone is set at 230° C., the temperature of the fourth zone is set at 230° C., and the temperature of the fifth zone is set at 230° C.; and the rotational speed of a main engine is 300 rpm; and
This step 3: mounting a top mold 3 and a bottom mold 4 of an injection mold on an injection molding machine, placing a bipolar plate body 1 between the top mold 3 and the bottom mold 4, injecting molten modified polypropylene into a cavity of the top mold 3 and the bottom mold 4, the cavity for forming a housing surrounding a circumferential edge region of the bipolar plate body, cooling and then demolding to obtain a bipolar plate structure with a housing, that is, a bipolar plate structure including the bipolar plate body 1 and the housing 2 in the form of an integrated structure.

### Performance Tests

Performance tests were carried out on Examples 1 and 2 and Comparative Example 1, wherein the thickness of the housings of the bipolar plate structures was tested according to Standard GB/T 6672-2001, the tensile strength of the housings was tested according to Standard GB/T 1040-2006, the elongation at break of the housings was tested according to Standard GB/T 1040-2006, the volume resistivity of the housings was tested according to Standard GB/T 1410-2006, and the dielectric strength of the housings was tested according to Standard GB/T 1408-2006. The results are shown in Table 1:

TABLE 1

| | Thick- | Tensile | Elongation | Volume | Dielectric |
|---|---|---|---|---|---|
| Performance | ness, | Strength, | at Break, | Resistivity, | Strength, |
| Index | cm | MPa | % | Ω · m | kV/mm |
| Example 1 | 0.013 | 36 | 180 | 10¹⁹ | 120 |
| Example 2 | 0.014 | 32 | 190 | 10¹⁹ | 115 |
| Comparative | 0.013 | 28 | 130 | 10¹⁸ | 95 |
| Example 1 | | | | | |

The oxidation resistance and aging resistance of the housings were tested according to the standard GB/T 7762-2014, and the results are shown in Table 2:

TABLE 2

| | Crack | Crack | Crack |
|---|---|---|---|
| Performance | Appearance | Width | Density |
| Index | Time, h | Grade | Grade |
| Example 1 | 140 | 1 | a |
| Example 2 | 135 | 1 | a |
| Comparative | 78 | 3 | b |
| Example 1 | | | |

According to the results of Tables 1 and 2, it can be seen that, compared with Comparative Example 1, the modified polypropylene prepared by the inventors of the present application by appropriately selecting each specific component and using an appropriate ratio is particularly suitable for manufacturing the housing of the bipolar plate body. The housing has not only improved mechanical performance such as toughness but also enhanced aging resistance, oxidation resistance, insulation and other performance, which can better protect the bipolar plate body, especially the circumferential edge region of the bipolar plate body not covered by the electrode material, make it more resistant to corrosion by the electrolyte, avoid leakage, prolong the service life of the bipolar plate, enhance the overall performance of the bipolar plate, and better adapt to the use environment of the flow battery.

Although the embodiments disclosed in the present application have been described above, the described content is only embodiments adopted to facilitate the understanding of the present application, and is not intended to limit the present application. Any person skilled in the art may make any modifications and variations in the form and details of implementation without departing from the spirit and scope disclosed in the present application, but the scope of protection of the present application should be defined by the appended claims.

1. A bipolar plate structure, characterized by comprising a bipolar plate body, both side surfaces of which each comprise a covered region covered by an electrode and a circumferential edge region not covered by the electrode;
wherein the circumferential edge region is covered by a housing made of a modified polypropylene, and the modified polypropylene is prepared by blending and modifying polypropylene-graft-maleic anhydride, poly(ethylene-octene)-graft-maleic anhydride and polypropylene.

2. The bipolar plate structure according to claim 1, wherein raw materials for preparing the modified polypropylene comprise, in parts by weight, 55 to 95 parts of polypropylene, 5 to 15 parts of polypropylene-graft-maleic anhydride, 10 to 20 parts of poly(ethylene-octene)-graft-maleic anhydride, 1 to 2 parts of nano SiO₂, 1 to 2 parts of talc, 0.5 to 1 part of a coupling agent, 0.1 to 1.5 parts of carbon black, and 0.3 to 1.4 parts of an antioxidant.

3. The bipolar plate structure according to claim 2, wherein the antioxidant is one or both selected from antioxidant 168 and antioxidant 1010.

4. The bipolar plate structure according to claim 2, wherein the coupling agent is one or more selected from coupling agents KH-550, KH-560 and KH570, 3-aminopropyltrimethoxysilane and vinyltriethoxysilane.

5. The bipolar plate structure according to claim 1, wherein the housing and the bipolar plate body form an integrated structure.

6. A method of manufacturing the bipolar plate structure according to claim 1, characterized by comprising the following steps:
weighing and mixing components to form a raw material mixture;
melt-kneading, extruding, cooling and drying, and pelletizing the raw material mixture to obtain modified polypropylene particles;
mounting a bipolar plate body into an injection mold; and
injecting molten modified polypropylene particles into the injection mold and injection-molding, cooling and demolding to obtain a bipolar plate structure with a housing.

7. The method according to claim 6, wherein the injection mold has a cavity surrounding a circumferential edge of the bipolar plate body, and the molten modified polypropylene particles are injected into the cavity to form a housing that forms an integrated structure with the bipolar plate body.

8. The method according to claim 6, wherein the extruding is carried out by a twin-screw extruder; the twin-screw extruder comprises a first zone, a second zone, a third zone, a fourth zone, and a fifth zone in sequence; the temperature of the first zone is set in the range of 150° C. to 180° C., the temperature of the second zone is set in the range of 200° C. to 220° C., the temperature of the third zone is set in the range of 220° C. to 240° C., the temperature of the fourth zone is set in the range of 220° C. to 240° C., and the temperature of the fifth zone is set in the range of 220° C. to 240° C.; and the rotational speed of a main engine is 300 rpm.

9. A flow battery, characterized by comprising the bipolar plate structure according to claim 1.

10. The flow battery according to claim 9, wherein the flow battery is any one selected from an all-vanadium flow battery, an iron-chromium flow battery, a zinc-iron flow battery, and a zinc-bromine flow battery.
